(19) United States
(12) Patent Application Publication
(10) Pub. No.: US 2019/0202271 A1
(43) Pub. Date: Jul. 4, 2019

(54) AIR OUTLET FOR A VEHICLE

(71) Applicant: Summit Polymers, Inc., Portage, MI (US)

(72) Inventors: James Lawrence Brand, Galesburg, MI (US); Eric Steven Jacobsma, Kalamazoo, MI (US); Hui Gao, Portage, MI (US); Daniel A. Stanek, Decatur, MI (US); Lawrence Michael Jones, Three Rivers, MI (US); William Morison, Portage, MI (US)

(73) Assignee: Summit Polymers, Inc., Portage, MI (US)

(21) Appl. No.: 15/951,293

(22) Filed: Apr. 12, 2018

Related U.S. Application Data
(60) Provisional application No. 62/611,631, filed on Dec. 29, 2017.

(51) Int. Cl. B60H 1/34

(52) U.S. Cl. CPC B60H 1/3428; B60H 2001/3464; B60H 2001/3471

(57) ABSTRACT

An air outlet for controlling airflow in a vehicle includes a housing having an air inlet and an air outlet, with first and second walls between the air inlet and the air outlet wherein the first wall is spaced from the second wall, an airfoil located within the housing, and a handle moveably mounted to the airfoil by a coupling.

### CROSS REFERENCE TO RELATED APPLICATION

This application claims the benefit of U.S. Provisional Patent Application No. 62/611,631, filed Dec. 29, 2017, which is incorporated herein by reference in its entirety.

### BACKGROUND

A vehicle ventilation system can include an air outlet that transfers temperature-controlled air into the vehicle cabin. The air outlet can include a fluid passageway coupled with a source of air having a predetermined temperature and velocity. Typically, the fluid passageway includes at least one adjustable directional vane that can direct the flow of air traveling through the fluid passageway parallel to the angle of the directional vane.

### BRIEF SUMMARY

In one aspect, the disclosure relates to an air outlet for controlling airflow in a vehicle including a housing having an air inlet and an air outlet, with first and second walls between the air inlet and the air outlet wherein the first wall is spaced from the second wall, an airfoil located within the housing and having a leading edge and a trailing edge where the leading edge generally faces the air inlet and the trailing edge generally faces the air outlet, and a handle moveably mounted to the airfoil by a coupling wherein movement of the handle toward the first wall causes the coupling to urge the leading edge toward the first wall and movement of the handle toward the second wall causes the coupling to urge the leading edge toward the second wall, wherein airflow around the airfoil is urged in the same direction as the handle by a Coanda effect around the airfoil.

In another aspect, the disclosure relates to an air outlet for controlling airflow in a vehicle including a housing having an air inlet and an air outlet, with first and second walls extending from the air inlet and the air outlet wherein the first wall is spaced from the second wall, and the first and second walls have a concave curvature, a vane located within the housing and having a leading edge and a trailing edge where the leading edge generally faces the air inlet and the trailing edge generally faces the air outlet, and having convex surfaces facing the concave curvatures of the first and second walls, between the leading edge and the trailing edge, and a handle moveably mounted to the vane by a coupling wherein movement of the handle toward the first wall causes the coupling to urge the leading edge toward the first wall and movement of the handle toward the second wall causes the coupling to urge the leading edge toward the second wall, wherein airflow around the vane is urged in the same direction as the handle between the convex and concave surfaces.

### BRIEF DESCRIPTION OF THE DRAWINGS

In the drawings:

FIG. 1 illustrates an air outlet for a vehicle according to various aspects described herein.

FIG. 2 illustrates a cutaway bottom view of the air outlet of FIG. 1 in a first position according to various aspects described herein.

FIG. 3 illustrates the air outlet of FIG. 2A in a second position according to various aspects described herein.

FIG. 4 illustrates a cross-section along line IV-IV of FIG. 1 according to various aspects described herein.

FIG. 5 illustrates a cross-section along line V-V of FIG. 1 according to various aspects described herein.

### DESCRIPTION OF EMBODIMENTS OF THE INVENTION

The described embodiments of the present disclosure are directed to an air outlet for a vehicle ventilation system. In one embodiment, an air outlet includes an airfoil configured to generate a Coanda effect to direct the flow of air into the vehicle cabin. It will be understood, however, that the disclosure is not so limited to vehicles and may have general applicability for any ventilation system.

All directional references (e.g., radial, axial, proximal, distal, upper, lower, upward, downward, left, right, lateral, front, back, top, bottom, above, below, vertical, horizontal, clockwise, counterclockwise, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary. Furthermore, “a set” as used herein can include any number of a particular element, including only one.

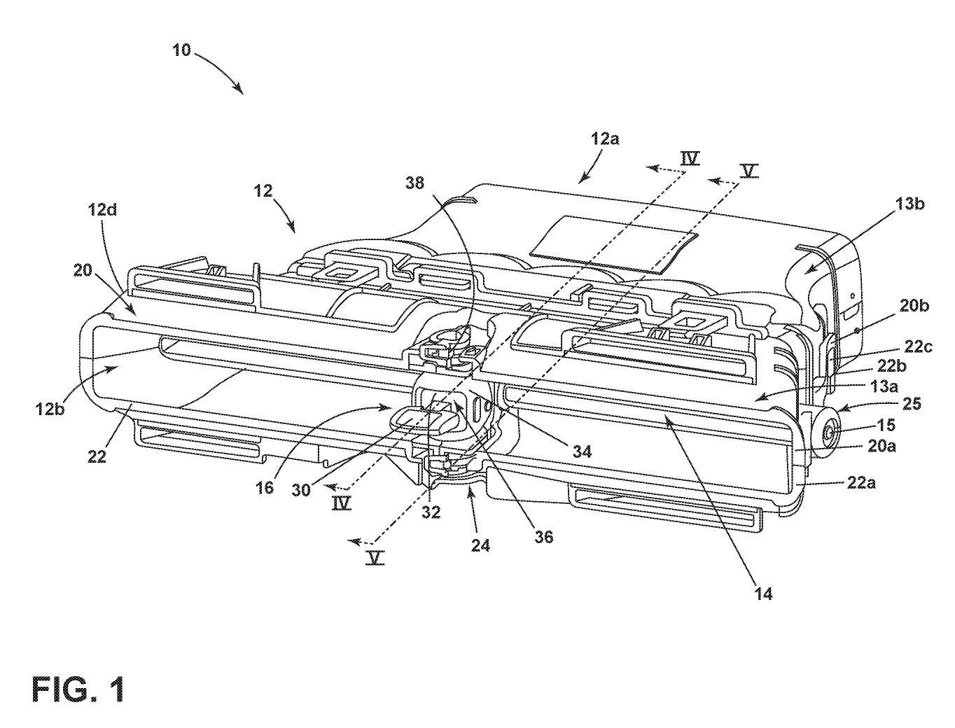

FIG. 1 illustrates a perspective view on an air outlet 10 for a vehicle. The air outlet 10 is typically installed in at least one location within the vehicle cabin, such as a dashboard or a door interior. The components of the air outlet 10 can be made of any suitable material, such as a rigid polymeric material. The air outlet 10 includes a housing 12 having an inlet 12a and an outlet 12b, an airfoil, or vane, 14, and a joystick, or handle 16.

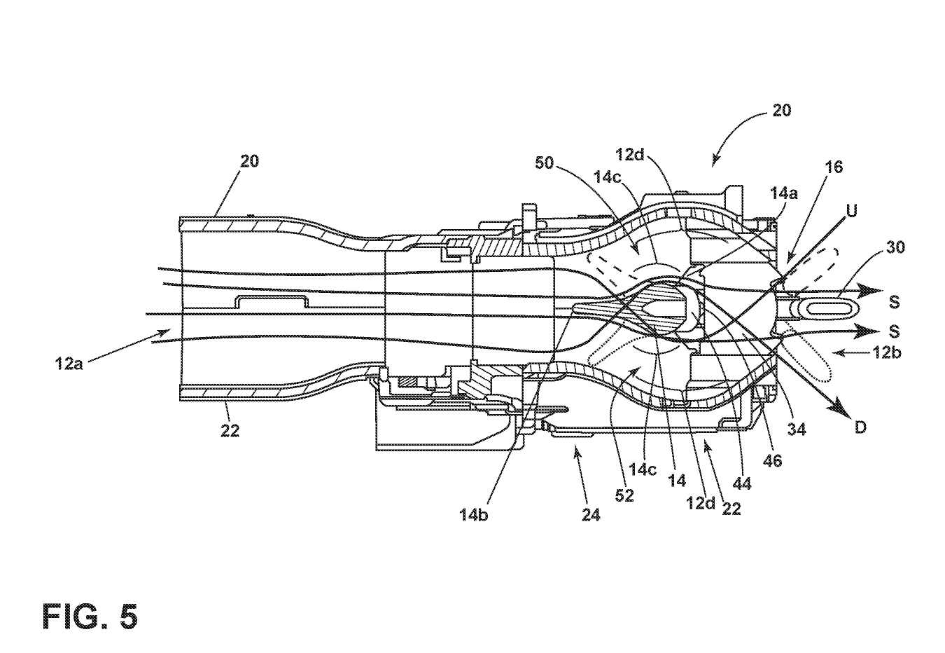

The housing 12 can include a first wall, or top housing 20, coupled to a second wall, or bottom housing 22. The top housing 20 and the bottom housing 22 extend from the air inlet 12a to the air outlet 12b and are spaced, forming an interior. The top housing 20 and the bottom housing 22 can include a concave curvature 12d near the air outlet 12b (better seen in FIG. 5). The top housing 20 can include a first piece 13a and a second piece 13b, corresponding, respectively, to a front and back of the housing 12 where the first piece 13a and second piece 13b are coupled to form the top housing 20. While not shown in FIG. 1, the bottom housing 22 can also include a first piece and a second piece that are coupled to form the bottom housing. The top housing 20 and the bottom housing 22 can include a spaced set of sidewalls, or sides 20a and 22a and each set of sides 20a and 22a can be coupled by mating portions 20b and 22b disposed on the sides 20a and 22a, or any other suitable method such as by the use of fasteners or welding. Mating portion 20b can include a recessed portion 20b in the top housing side 20a while mating portion 22b can include a projection 22b that extends within the recessed portion 20b. The projection 22b can include a clip 22c that fastens the projection 22b to the recessed portion 20b. The airfoil 14 can be coupled to the housing 12 at the sides 20a and 22a and preferably extends between one set of sides 20a and 22a and another set of sides 20a and 22a where a shaft portion 15 of the airfoil 14 can be inserted within a cylindrical coupling 25 formed by the sides 20a and 22a.

The bottom housing 22 can include a gear assembly 24 coupled with the handle 16 to control the left and right movement of the handle 16. The handle 16 can be in the form of a joystick and can include a lever 30 and a ball, or spherical portion 32. The spherical portion 32 can include a socket, or outer shell 34 having an aperture 36 where the lever 30 extends outwardly from the aperture 36. A shaft 38 can extend from the outer shell 34, or the spherical portion 32, to couple the handle 16 to the top housing 20, the bottom housing 22, and the gear assembly 24.

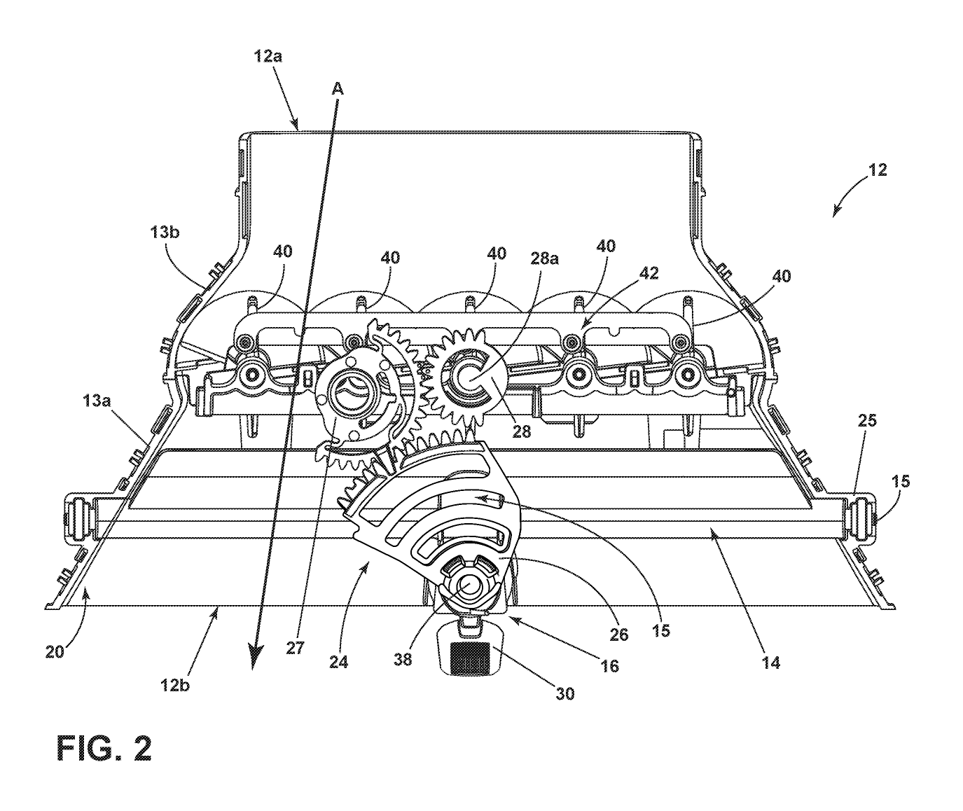

FIG. 2 illustrates a bottom view of the air outlet 10 having the bottom housing 22 removed to more clearly view components of the air outlet 10. The gear assembly 24 can include a driving gear 26, an idler gear 27, and a driven gear 28. Vertical directional vanes 40 can be included within the housing 12 disposed between the housing inlet 12a and the airfoil 14, and can be fixed relative to each other via a top plate 42. The driven gear 28 can be coupled to the top plate 42 via a shaft 28a to impart rotation to the directional vanes 40 from left and right rotation of the handle 16, which can be coupled to the driving gear 26. The directional vanes 40 can be rotated to direct air left or right relative to the housing outlet 12b. A first handle position is shown in FIG. 2 where the handle 16 is in a centered position and the directional vanes 40 are in an open position such that the directional vanes 40 are generally perpendicular to the housing outlet 12b. In the first handle position, air can flow from the housing inlet 12, between the directional vanes 40, and through the housing outlet 12b, as seen by airflow A.

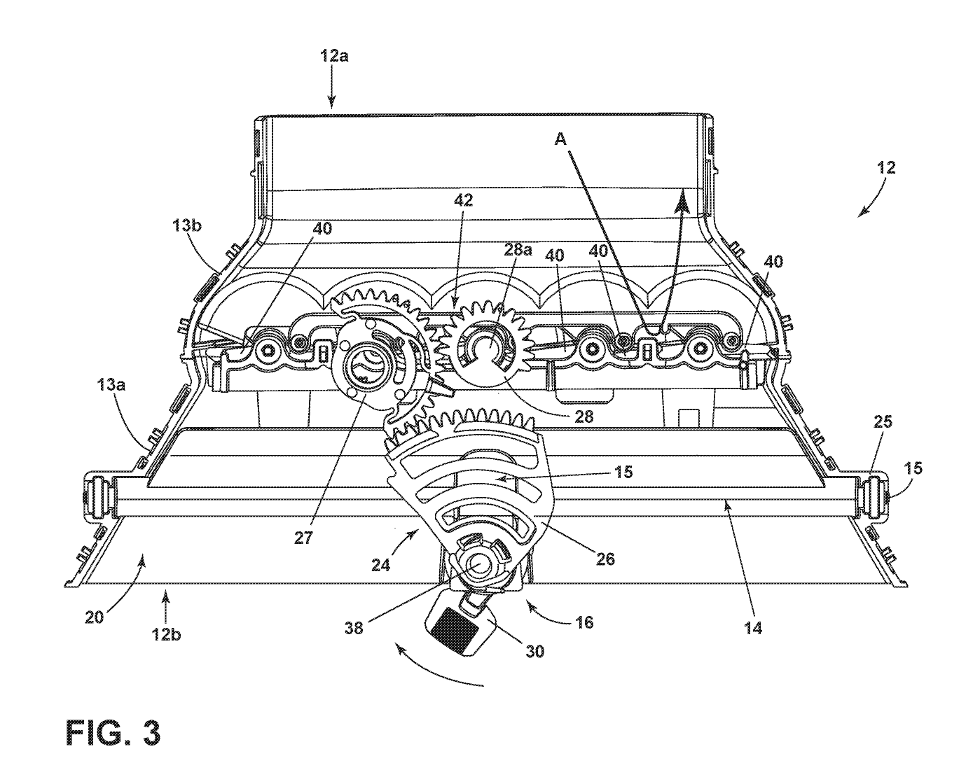

FIG. 3 illustrates the air outlet 10 of FIG. 2 in a second handle position where the directional vanes 40 are in a closed position such that the directional vanes 40 are generally parallel to the housing outlet 12b, precluding air from flowing through the housing outlet 12b, as shown by airflow A. In the second handle position, the handle 16 is moved leftward and the directional vanes 40 abut each other in order to block air from flowing between the directional vanes 40. While only a first and second handle position are shown and described, the air outlet 10 can include a plurality of handle positions that result in a range of positions for the directional vanes 40 in between the open and closed positions. Additionally, while the closed position of the directional vanes 40 shown in FIG. 3 results from the handle 16 being moved in a leftward position, the directional vanes 40 can also be in a closed position when the handle 16 is in a rightward position.

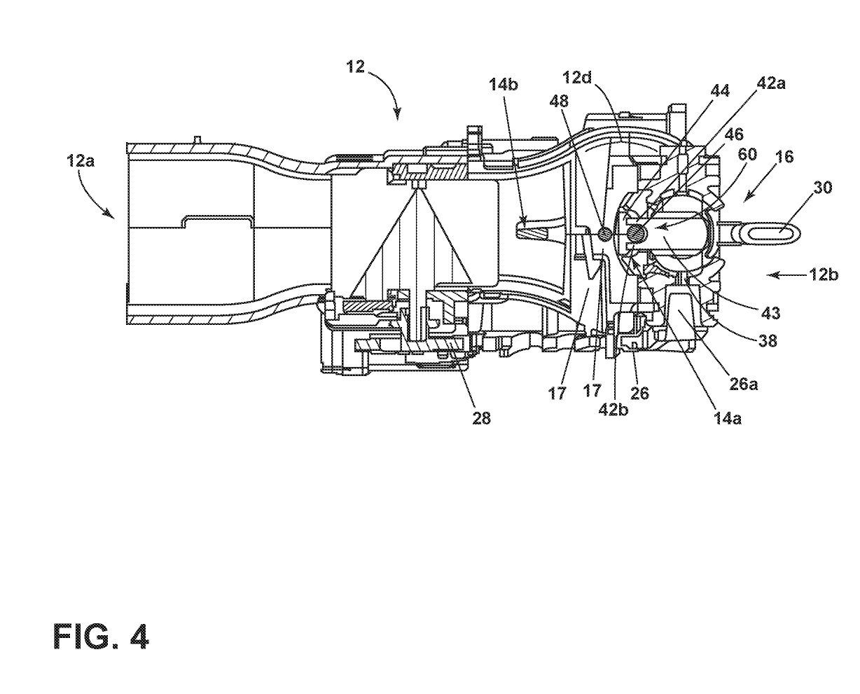

FIG. 4 illustrates a cross-section along line IV-IV of FIG. 1 more clearly illustrating the handle 16 and a portion of the airfoil 14. The airfoil 14 can include a leading edge 14b that generally faces the air inlet 12a and a trailing edge 12a that generally faces the air outlet 12b. The driving gear 26 can include a shaft 26a that is received within a recess 38 of the handle shaft 38 to couple the handle 16 and the driving gear 26. The handle 16 can also be moveably mounted to the airfoil 14 by a coupling 60. The coupling 60 of the handle 16 and the airfoil 14 can include a hook 43 extending from the spherical portion 32 of the handle 16 towards the air inlet 12a of the housing 12. The hook 43 can be coupled to a first pin 46 on a flange 44, which is coupled to the airfoil 14. The flange 44 can include a second pin 48 that couples with an interior wall 17 within the housing 12 to fix the position of a trailing edge 14a of the airfoil 14. The flange 44 can be coupled within a recess 15 (as seen best in FIGS. 2 and 3) in the airfoil 14 where the recess 15 is adjacent the handle 16. Furthermore, two flanges 44 can be coupled within the recess 15 in the airfoil 14 such that the first pin and second pin 46, 48 span from one flange 44 to the other flange 44 and extend across the recess 15. Furthermore, while the recess 15 in the airfoil 14 and the handle 16 are shown in the center of the housing outlet 12b, it is possible for the recess 15 and the handle 16 to be located in any left or right position parallel to the housing outlet 12b.

The positions of the trailing edge 14a and the leading edge 14b of the airfoil 14 can be adjusted via up and down movement of the handle 16. In the case that the handle 16 is pushed up, a first end 42a of the hook 43 can push downwardly on the first pin 46, causing the airfoil 14 to rotate such that the leading edge 14b is urged toward the top housing 20, or pointed upwards in the same direction of the handle 16 and the trailing edge 14a is pointed downwards. In the case that the handle 16 is pushed down, a second end 42b of the hook 43 can push upwardly on the first pin 46, causing the airfoil 14 to rotate such that the leading edge 14b is urged toward the bottom housing 22, or pointed downwards in the same direction of the handle 16 and the trailing edge 14a is pointed upwards. Thus, upward movement of the handle 16 causes the leading edge 14b to move upwards, and downward movement of the handle 16 causes the leading edge 14b to move downwards.

FIG. 5 illustrates a cross-section along line V-V of FIG. 1 more clearly illustrating the airfoil 14 and airflow through the housing 12 and the air outlet 10. While the directional vanes 40 control the left and right movement of air flowing through the air outlet 10, the airfoil 14 controls the up and down movement of air flowing through the air outlet 10. The airfoil 14 can have curved, convex surfaces 14c facing the concave curvatures 12d of the top housing 20 and the bottom housing 22. The curved surfaces of the airfoil 14 generate a Coanda effect on the air flowing adjacent to the airfoil. The Coanda effect causes air to adhere to the curved surfaces of the airfoil 14 such that the air will flow along the airfoil 14 from the leading edge 14b until it reaches the trailing edge 14a where the air can continue to flow around the trailing edge. Thus, airflow around the airfoil 14 is urged in the same direction as the handle 16 by the Coanda effect around the airfoil 14.

For example, when the handle 16 is in a neutral position where it is centered between the top housing 20 and the bottom housing 22, air will flow adjacent the airfoil 14 and tend to flow straight out of the housing outlet 12b, as seen by airflow S. Airflow S travels from the housing inlet 12a against the leading edge 14b and around each side of the airfoil 14 where the airflow S exits the air outlet 10 in a generally horizontal path. Airflow adjacent the concave curvatures 12d of the top and bottom housings 20, 22 tends to follow the directions of their respective curvatures, which directions cancel each other as the air exits the housing outlet 12b. In the case where the handle 16 is pushed upwards, the leading edge 14b also points upwards, as shown by the dashed lines, and airflow U will tend to flow upwardly out of the housing outlet 12b due to the Coanda effect adjacent the airfoil and/or the curvature in the bottom housing 22. In the case where the handle 16 is pushed completely upwards towards the top housing 20, or in an uppermost position, the leading edge 14b can be dimensioned to block airflow from flowing through a first airflow channel 50 of the housing 12. The leading edge 14b can block airflow by contacting the top housing 20. The first airflow channel 50 of the housing 12 can be formed by the top housing 20. Airflow U travels against the leading edge 14b and along the side of the airfoil 14 that faces the housing inlet 12a. Thus, airflow U will curve downwardly and back up towards the trailing edge 14a, where airflow U can exit the housing outlet 12b in the direction of the top housing 20. Furthermore, when the handle 16 is pushed downwards, the leading edge 14b also points downwards, as shown by the dotted lines, and airflow D will tend to flow downwardly out of the housing outlet 12b due to the Coanda effect adjacent the airfoil and/or the curvature in the top housing 20. In the case where the handle 16 is pushed completely downwards, or in a lowermost position, the leading edge 14b can be dimensioned to block airflow from flowing through a second airflow channel 52 of the housing 12. The leading edge 14b can block airflow by contacting the bottom housing 22. The second airflow channel 52 of the housing 12 can be formed by the bottom housing 22. Airflow D travels against the leading edge 14b and along the side of the airfoil 14 that faces the housing inlet 12a. Thus, airflow D will curve upwardly and back down towards the trailing edge 14a, where airflow D can exit the housing outlet 12b in the direction of the bottom housing 22.

Alternatively, in the case where the handle 16 is not in the uppermost or lowermost position, the leading edge 14b may only partially block airflow from flowing through the first airflow channel 50 or the second airflow channel 52, respectively. It is also contemplated that the handle 16 can be only partially pushed upwards or downwards, yet completely dimensioned to block airflow from flowing through the first airflow channel 50 or the second airflow channel 52, respectively.

Aspects of the present disclosure provide for a variety of benefits, including a more efficient method of venting air from the air outlet to a vehicle cabin. The airfoil within the air outlet provides for a high aspect ratio, slim vent that utilizes the Coanda effect as described herein.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

While embodiments of the disclosure have been specifically described in connection with certain specific embodiments thereof, it is to be understood that this is by way of illustration and not of limitation. For example, the airfoil or vane 14 is not strictly limited to a teardrop airfoil shape, but may include any shape so long as there are concave curvatures on upper and lower sides of the vane. Reasonable variation and modification are possible within the scope of the forgoing disclosure and drawings without departing from the spirit of the disclosure.

What is claimed is:

1. An air outlet for controlling airflow in a vehicle comprising:
a housing having an air inlet and an air outlet, with first and second walls between the air inlet and the air outlet wherein the first wall is spaced from the second wall;
an airfoil located within the housing and having a leading edge and a trailing edge where the leading edge generally faces the air inlet and the trailing edge generally faces the air outlet; and
a handle moveably mounted to the airfoil by a coupling wherein movement of the handle toward the first wall causes the coupling to urge the leading edge toward the first wall and movement of the handle toward the second wall causes the coupling to urge the leading edge toward the second wall;
wherein airflow around the airfoil is urged in the same direction as the handle by a Coanda effect around the airfoil.

2. The air outlet of claim 1, wherein a dimension of the leading edge is such that when the leading edge is urged towards the first wall, the leading edge is dimensioned to effectively block airflow from flowing through a first airflow channel of the air outlet when the handle is urged towards the first wall.

3. The air outlet of claim 1, wherein a dimension of the leading edge is such that when the leading edge is urged towards the second wall, the leading edge is dimensioned to effectively block airflow from flowing through a second channel of the air outlet when the handle is urged toward the second wall.

4. The air outlet of claim 1, further comprising vertical directional vanes disposed upstream the airfoil that can be moved left or right to open or close the air outlet with left or right movement of the handle.

5. The air outlet of claim 1, wherein the housing further comprises a top wall and a bottom wall adjoining the first and second walls.

6. The air outlet of claim 1, wherein the airfoil extends from the first wall to the second wall.

7. The air outlet of claim 6, wherein at least one of the first and second walls further comprises a cylindrical coupling formed by a first wall side and a second wall side and a shaft coupled with the airfoil is inserted within the cylindrical coupling.

8. The air outlet of claim 1, wherein the handle further comprises a lever coupled with a ball and a socket with an aperture and the lever extends outwardly from the aperture.

9. The air outlet of claim 8, wherein the handle further comprises a shaft extending from the handle to couple the handle to a gear assembly for driving vertical directional vanes disposed upstream the airfoil between the leading edge and the air inlet.

10. The air outlet of claim 8, wherein the coupling further comprises a hook coupled to the ball and the airfoil.

11. The air outlet of claim 10, wherein the hook is coupled to the airfoil via at least one pin.

12. The air outlet of claim 1, wherein airflow exits the housing in a generally horizontal path when the handle is in a neutral position.

13. An air outlet for controlling airflow in a vehicle comprising:
a housing having an air inlet and an air outlet, with first and second walls extending from the air inlet and the air outlet wherein the first wall is spaced from the second wall, and the first and second walls have a concave curvature;
a vane located within the housing and having a leading edge and a trailing edge where the leading edge generally faces the air inlet and the trailing edge generally faces the air outlet, and having convex surfaces facing the concave curvatures of the first and second walls, between the leading edge and the trailing edge; and
a handle moveably mounted to the vane by a coupling wherein movement of the handle toward the first wall causes the coupling to urge the leading edge toward the first wall and movement of the handle toward the second wall causes the coupling to urge the leading edge toward the second wall;
wherein airflow around the vane is urged in the same direction as the handle between the convex and concave surfaces.

14. The air outlet of claim 13, wherein a dimension of the leading edge is such that when the leading edge is urged towards the first wall, the leading edge contacts the first wall and blocks airflow from flowing through a first airflow channel of the air outlet when the handle is urged towards the first wall.

15. The air outlet of claim 13, further comprising vertical directional vanes disposed upstream the vane that can be moved laterally to open or close the air outlet with lateral movement of the handle.

16. The air outlet of claim 13, wherein the first wall and the second wall have a set of sidewalls that couple the first wall and the second wall via mating portions disposed on the sidewalls to form an interior.

17. The air outlet of claim 13, wherein the vane extends from the first wall to the second wall.

18. The air outlet of claim 17, wherein at least one of the first and second walls further comprises a cylindrical coupling formed by a first wall sidewall and a second wall sidewall and a shaft is coupled to the vane and inserted within the cylindrical coupling.

19. The air outlet of claim 13, wherein the handle further comprises a coupling coupled to the vane.

20. The air outlet of claim 19, wherein the coupling includes a hook coupled to a pin.
